(19) United States
(12) Patent Application Publication
(10) Pub. No.: US 2004/0115534 A1
(43) Pub. Date: Jun. 17, 2004

(54) Method for preparing Li-Mn-Ni oxide for lithium secondary battery

(76) Inventors: Yong-Joon Park, Daejon (KR); Young-Sik Hong, Daejon (KR); Xianglan Wu, Daejon (KR); Kwang Sun Ryu, Daejon (KR); Kwang Man Kim, Daejon (KR); Young-Gi Lee, Daejon (KR); Soon Ho Chang, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/682,336

(22) Filed: Oct. 8, 2003

(30) Foreign Application Priority Data
Nov. 7, 2002 (KR) 2002-68731

(51) Int. Cl. H01M 4/50; H01M 4/52; C01G 45/12; C01G 53/04

(52) U.S. Cl. 429/231.1; 429/224; 429/223; 423/594.4; 423/599

(57) ABSTRACT

Provided is a method for preparing a Li—Mn—Ni oxide for a lithium secondary battery having a composition of Li[NiₓLi_{(1/3-2x/3)}Mn_{(2/3-X/3)}O₂ (0.05<X<0.6), including the steps of: a] preparing an aqueous solution by resolving lithium salt, manganese salt and nickel salt into distilled water; b) forming gel by heating the aqueous solution; c) preparing oxide powder by burning the gel; d) performing a first thermal treatment on the oxide powder, and grinding the resultant; and e) performing a second thermal treatment on the resultant powder, and grinding the resultant. The technology of the present invention can prepare a Li—Mn—Ni oxide having a composition of Li[NiₓLi_{(1/3-2x/3)}Mn_{(2/3-x/3)}O₂ (0.05<X<0.6) to be used as a cathode material of a lithium secondary battery having a stable and excellent electrochemical characteristics.

### FIELD OF THE INVENTION

The present invention relates to a method for preparing Li—Mn—Ni oxide for a lithium secondary battery.

### DESCRIPTION OF RELATED ART

LiCoO₂ is used representatively as a cathode material for a lithium secondary battery, which is commonly used at present. Since LiCoO₂ discharges high voltage, has a capacity of 140-160 mAh/g and has a stable cyclic properties and discharge characteristics, it is used for most of the current lithium secondary batteries. However, LiCoO₂ may contaminate the environment and it is very expensive to make. For these reasons, many researchers have studied to find a new cathode material to replace LiCoO₂.

Other cathode materials, such as LiNiO₂ and LiMn₂O₄, are developed. LiNiO₂ is inexpensive and provides large capacity. It can provide a capacity of 160˜180 mAh/g according to a compounding method. Despite these advantages, LiNiO₂ has a problem that it reacts to electrolyte in a battery and spoils the stability of the battery when the battery is charged and discharged successively. Also, since LiMn₂O₄ has small discharge capacity and low electric conductivity compared to other cathode materials, it is rarely applied to batteries, actually. Therefore, Li—Mn—Ni oxide is getting a spotlight as an alternative to the cathode material for conventional lithium batteries.

Korean Patent Laid-Open No. 2002-64322 discloses a method for preparing Li—Mn—Ni oxide powder for lithium batteries having excellent electrochemical characteristics at a cheap production cost by replacing some Ni of conventional LiNiO₂ with Mn. In the patent, an Mn ion is substituted for Ni³⁺ to become Mn³⁺. As a result, Li—Mn—Ni oxide (Li(MnₓNi₁₋ₓ)O₂) (0.05<X<0.5) is formed and the discharge capacity of the Li(MnₓNi₁₋ₓ)O₂ is not more than 170 mAh/g. Since this is not larger than the conventional LiNiO₂, this Li—Mn—Ni oxide powder is not efficient.

However, a recent study by Dahn et al. suggests a new method for compounding Li—Mn—Ni oxide having a high discharge capacity of over 200 mAh/g by substituting Ni²⁺, Li⁺ and Mn⁴⁺ for [Li_{1/3}Mn_{2/3}] while maintaining Mn as a quadrivalent ion in Li[Li_{1/3}Mn_{2/3}]O₂′. It is reported in a paper, ‘Synthesis, Structure, and Electrochemical Behavior of Li[NiₓLi_{(1/3-2x/3)}Mn_{(2/3-x/3)}]O₂′, by Dahn et al., in the Journal of The Electrochemical Society, 149(6) A778-A791, 2002. Here, the Li—Mn—Ni oxide can be expressed as Li[NiₓLi_{(1/3-2x/3)}Mn_{(2/3-x/3)}]O₂ (0.05<X<0.6) in consideration of the valence of the monovalent Li ion, bivalent Ni ion, and quadrivalent Mn ion. In Dahn et al., the Li—Mn—Ni oxide is formed by resolving manganese salt and nickel salt in water, adding lithium hydroxide (LiOH) to the aqueous water to obtain metal hydroxide (M(OH)₂) precipitate, mixing the hydroxide (M(OH)₂) precipitate with lithium hydroxide (LiOH) again, and then performing a thermal treatment.

This method tries to place metal ions, such as Mn and Ni, at the position of [Li_{1/3}Mn_{2/3}] evenly by forming metal hydroxide to promote mixing between positive ions and negative ions, because it is hard to place the metal ions in the position of [Li_{1/3}Mn_{2/3}] evenly mixed. The method of Dahn et al. makes it possible to obtain multi-layer Li—Mn—Ni oxide having stable battery characteristics. However, it is complicated to form metal hydroxide powder, since the metal hydroxide powder is formed after going through a precipitating process, a filtering process, a washing process and a drying process. Moreover, the production cost is expensive. Therefore, this method suggested by Dahn et al. is not suitable for mass-production.

### SUMMARY OF THE INVENTION

It is, therefore, an object of the present invention to provide a method for preparing Li—Mn—Ni compound having a composition of Li[NiₓLi_{(1/3-2x/3)}Mn_{(2/3-x/3)}]O₂ (0.05<X<0.6), which is known to have a stable and excellent discharge capacity, at a low cost through more simplified processes than conventional method of forming metal hydroxide.

In accordance with an aspect of the present invention, there is provided a method for forming multi-layer fine Li—Mn—Li oxide by resolving lithium salt, manganese salt and nickel salt into distilled water, heating the aqueous water to form gel, heating the gel and grinding the burnt gel, and repeating the heating and grinding process.

That is, the present invention provides a method for preparing a Li—Mn—Ni oxide for lithium secondary batteries having a composition of Li[NiₓLi_{(1/3-2x/3)}Mn_{(2/3-x/3)}O₂ (0.05<X<0.6) by resolving lithium salt, manganese salt and nickel salt into distilled water, heating the aqueous water to form gel, burning the gel and grinding the burnt gel, performing a first thermal treatment on the powder and grinding the resultant, and performing a second thermal treatment on the ground powder and grinding the resultant. Desirably, the lithium salt, manganese salt and nickel salt are water-soluble salts, and the second thermal treatment is performed at a temperature of 700˜1000° C.

### BRIEF DESCRIPTION OF THE DRAWINGS

The above and other objects and features of the present invention will become apparent from the following description of the preferred embodiments given in conjunction with the accompanying drawings, in which:

FIG. 1 is a flowchart illustrating a method for preparing a Li—Mn—Ni oxide in accordance with the present invention;

FIG. 2 is a graph showing an X-ray diffraction pattern of the Li—Mn—Ni oxide prepared in accordance with an embodiment of the present invention;

FIG. 3 is a scanning electronic microscopic photograph showing the Li—Mn—Ni oxide prepared in accordance with the embodiment of the present invention;

FIG. 4 is a graph depicting the initial charge and discharge characteristics of the Li—Mn—Ni oxide prepared in accordance with the embodiment of the present invention; and

FIG. 5 is a graph depicting the initial charge and discharge characteristics of the Li—Mn—Ni oxide prepared in accordance with another embodiment of the present invention.

### DETAILED DESCRIPTION OF THE INVENTION

Other objects and aspects of the invention will become apparent from the following description of the embodiments with reference to the accompanying drawings, which is set forth hereinafter.

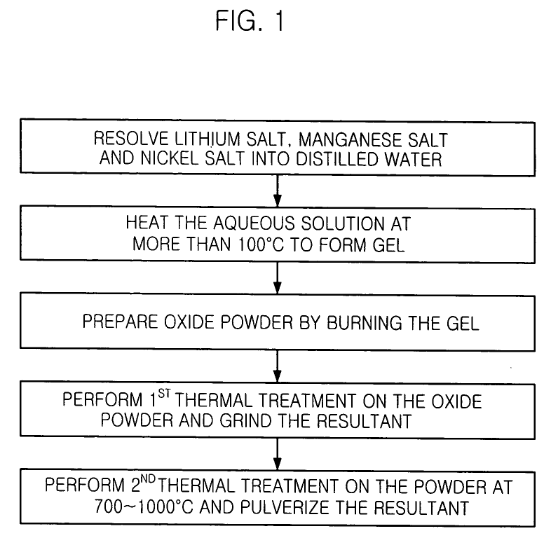

FIG. 1 is a flowchart illustrating a method for preparing Li—Mn—Ni oxide in accordance with the present invention. First, lithium salt, manganese salt and nickel salt are resolved into distilled water at a proper ratio for a desired composition. Desirably, the lithium salt, manganese salt and nickel salt are water-soluble salts. In particular, the lithium salt is lithium acetate dihydrate (CH₃CO₂Li.2H₂O), and the manganese salt is manganese acetate tetrahydrate ((CH₃CO₂)₂Mn.4H₂O). For the nickel salt, it is desirable to use nickel(II) nitrate hexahydrate (Ni(NO₃)₂.6H₂O). Besides, other water-soluble salts may be used. The composition ratio of the salts is Li[NiₓLi_{(1/3-2x/3)}Mn_{(2/3-x/3)}O₂ (0.05<X<0.6), recommended by Dahn et. al. in ‘Synthesis, Structure, and Electrochemical Behavior of Li[NiₓLi_{(1/3-2x/3)}Mn_{(2/3-x/3)}]O₂,’ Journal of The Electrochemical Society 149(6) A778-A791, 2002. If X is not more than 0.05 or not less than 0.06, the discharge capacity is decreased and, thus, they become unsuitable to be used as a cathode material for a lithium secondary battery. The amount of the distilled water is as much as to resolve the salts sufficiently. Since the distilled water is evaporated during the subsequent processes, there is no restriction on the amount of distilled water used.

Subsequently, the aqueous solution including lithium salt, manganese salt and nickel salt resolved is heated to remove water. The heating is performed at a temperature over 100° C. However, it is not desirable to heat the aqueous solution at a temperature higher than 100° C., because it is a waste of energy. When the water is removed from the aqueous solution, highly cohesive green gel is formed.

Subsequently, the gel is burned. When the gel is heated, remaining water is removed and fire starts due to the reaction of the acetate radical (COOH) and the nitrate radical (NO₃) in the gel, and the gel is burnt. The gel is heated at a temperature enough to ignite the gel. In the present invention, the gel is heated at a temperature of 400˜500° C. The gel lumps swell up by the gas generated during the process. The swollen gel lumps are ground to form fine oxide powder. Here, a first thermal treatment is performed on the powder at a temperature of 400˜500° C. to make a reaction of the acetate radical (COOH) and the nitrate radical (NO₃) which are not reacted enough during the burning process.

Subsequently, a second thermal treatment is performed on the ground powder at a temperature of 700˜1000° C. to form fine Li—Mn—Ni oxide with layered structure. If the temperature of the second thermal treatment is not more than 700° C., phases are not formed sufficiently. If it is not less than 1000° C., the resultant oxide has small discharge capacity, which is not desirable. The second thermal treatment is performed for 1-24 hours, desirably. If the thermal treatment is performed too short, reaction is not performed sufficiently. If it is performed too long, over-reaction occurs and, thus, discharge capacity is decreased when the resultant oxide is used as a cathode material for a secondary battery. The second thermal treatment time is controlled properly in consideration of the reaction temperature.

Hereinafter, embodiments of the present invention are described more in detail.

### EMBODIMENT 1

Lithium acetate dihydrate (CH₃CO₂Li.2H₂O), manganese acetate tetrahydrate ((CH₃CO₂)₂Mn.4H₂O), and nickel (II) nitrate hexahydrate (Ni(NO₃)₂.6H₂O) are resolved into distilled water at a predetermined composition ratio.

Representative mass ratios of the reagents are as shown in Table 1.

TABLE 1

| Composition | Ni(NO₃)₂.6H₂O | (CH₃CO₂)₂Mn.4H₂O | CH₃CO₂Li.2H₂O |
|---|---|---|---|
| LiMn_{0.5}Ni_{0.5}O₂ | 14.54 g | 12.25 g | 10.20 g |
| Li[Li_{0.11}Mn_{0.56}Ni_{0.33}]O₂ | 8.72 g | 12.25 g | 10.20 g |
| Li[Li_{0.17}Mn_{0.58}Ni_{0.25}]O₂ | 8.72 g | 17.16 g | 14.28 g |
| Li[Li_{0.22}Mn_{0.61}Ni_{0.17}]O₂ | 4.26 g | 13.48 g | 11.22 g |

The reagents of the masses described in Table 1 are resolved in 50˜150 ml of distilled water and mixed while being heated at 250° C. As a result transparent green aqueous solution is obtained.

The aqueous solution is heated to evaporate water and form highly cohesive gel. The gel is burnt at 400° C. to remove remaining water, and the gel swollen by gas during the burning process is ground to thereby form fine oxide powder. Then, a first thermal treatment is performed on the oxide powder at 500° C. for three hours, and then the resultant is ground.

Subsequently, a second thermal treatment is performed at 900° C. for three hours, and then the resultant is ground, too. Through these processes, multi-layer fine oxide is obtained.

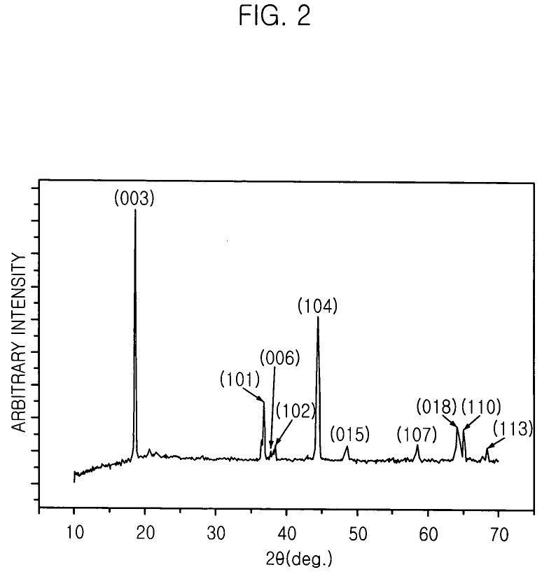

FIG. 2 is a graph showing an X-ray diffraction pattern of the Li—Mn—Ni oxide prepared in accordance with an embodiment of the present invention. FIG. 2 shows an X-ray diffraction pattern of a composition of Li[Li_{0.11}Mn_{0.56}Ni_{0.33}]O₂. We can see from the graph that Li[Li_{0.11}Mn_{0.56}Ni_{0.33}]O₂ has the same X-ray diffraction pattern as the Li—Mn—Ni oxide prepared by using the conventional method for forming metal hydroxide (M(OH)₂).

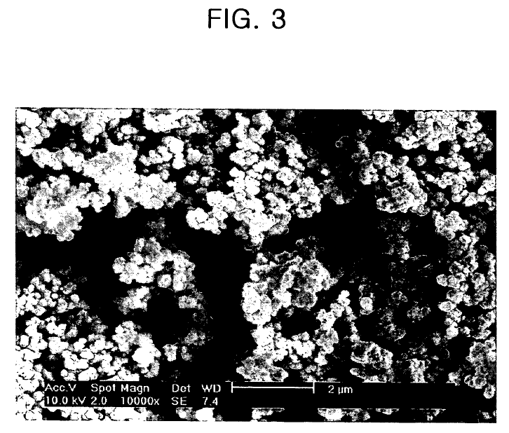

FIG. 3 is a scanning electronic microscopic photograph showing the Li—Mn—Ni oxide prepared in accordance with the embodiment of the present invention. In the photograph, it can be observed that a round powder particle has a size of around 0.1˜0.3 μm, which is very fine.

In order to verify the efficiency of Li—Mn—Ni oxide prepared in accordance with the present invention, the initial charge and discharge characteristics of the oxide are measured. To measure the characteristics, a cathode plate is fabricated by mixing the oxide powder prepared in accordance with the present invention 80 wt %, a conductive material 12 wt %, and binder 8 wt %. As for electrolyte, 1 M of lithium hexafluore phosphate (LiPF₆) salt is resolved in a solvent which is prepared by mixing ethylene carbonate (EC) and dimethylene carbonate (DMC) at a ratio of 1:1. The anode is lithium foil.

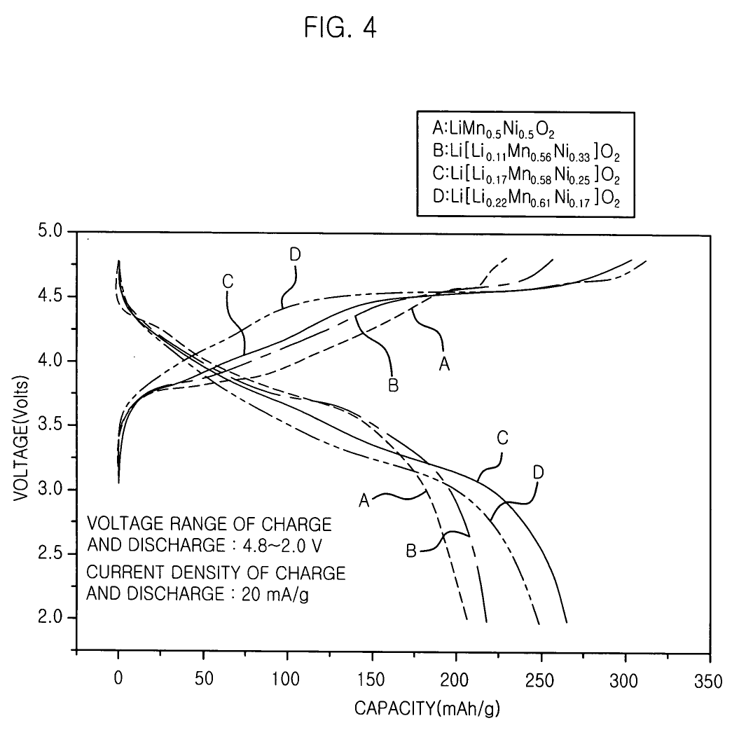

FIG. 4 is a graph depicting the initial charge and discharge characteristics of the Li—Mn—Ni oxide prepared in accordance with the embodiment of the present invention. In case where the charge-discharge current density of a battery is 20 mA/g and the battery is charged to 4.8 V and discharged to 2.0V, the initial discharge capacity of the Li—Mn—Ni oxide prepared based on the above composition ratio is ranged from 200 mA/g to 270 mA/g.

From this result, it can be seen that the cathode material of the present invention has larger initial discharge capacity than other sorts of cathode materials for lithium secondary batteries.

### EMBODIMENT 2

10.20 g of lithium acetate dihydrate (CH₃CO₂Li.2H₂O), 12.25 g of manganese acetate tetrahydrate ((CH₃CO₂)₂Mn.4H₂O), and 8.72 g of nickel (II) nitrate hexahydrate (Ni(NO₃)₂.6H₂O) are resolved into 100 ml of distilled water.

The aqueous solution is heated at 300° C. until the water is evaporated and highly cohesive green gel is obtained. The gel is burnt at 450° C. to remove the remaining water, and the swollen gel is ground to obtain fine oxide powder. The oxide powder goes through a first thermal treatment at 500° C. for three hours and ground. The powder is divided into three portions and a second thermal treatment is performed on the three portions of powder at different temperatures of 700° C., 900° C. and 1000° C. for three hours, respectively, and ground. Then, the efficiencies of the three portions of Li—Mn—Ni oxide prepared by different heating temperature of the second thermal treatment are measured.

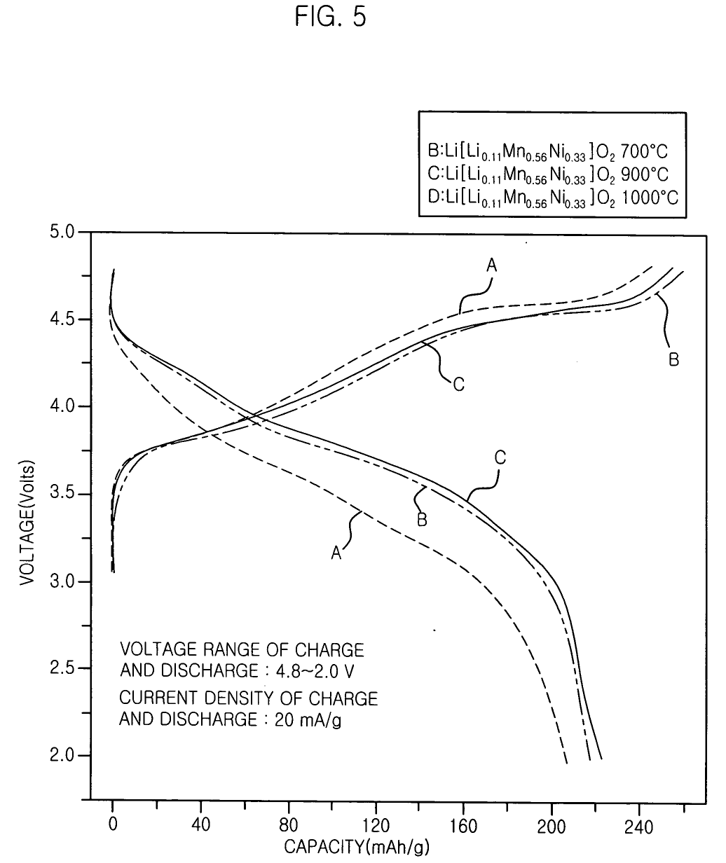

FIG. 5 is a graph depicting the initial charge and discharge characteristics of the Li—Mn—Ni oxide prepared in accordance with Embodiment 2 of the present invention. The characteristics of the oxide are measured using the same method of the embodiment 1. The charge-discharge current density of a battery is 20 mA/g and the battery is charged to 4.8 V and discharged to 2.0V. Then, all the portions of Li—Mn—Ni oxide prepared by different heating temperature of the second thermal treatment have initial discharge capacity ranged from 210 mA/g to 230 mA/g.

The technology of the present invention can prepare Li—Mn—Ni oxide having a stable composition ratio of Li[NiₓLi_{(1/3-2x/3)}Mn_{(2/3-x/3)}O₂ (0.05<X<0.6) by placing metal positive ions at a desired place evenly mixed through simple burning processes at a relatively low cost. In addition, the technology of this invention makes it possible to prepare a cathode material for the lithium secondary battery having excellent electrochemical characteristics by generating gas within gel during the heating process and, thus, forming fine oxide powder.

While the present invention has been described with respect to certain preferred embodiments, it will be apparent to those skilled in the art that various changes and modifications may be made without departing from the scope of the invention as defined in the following claims.

What is claimed is:

1. A method for preparing a Li—Mn—Ni oxide for a lithium secondary battery having a composition of Li[NiₓLi_{(1/3-2x/3)}Mn_{(2/3-x/3)}O₂ (0.05<X<0.6), comprising the steps of:
a) preparing an aqueous solution by resolving lithium salt, manganese salt and nickel salt into distilled water;
b) forming gel by heating the aqueous solution;
c) preparing oxide powder by burning the gel;
d) performing a first thermal treatment on the oxide powder, and grinding the resultant; and
e) performing a second thermal treatment on the resultant powder, and grinding the resultant.

2. The method as recited in claim 1, wherein the lithium salt, manganese salt and nickel salt are water-soluble salts.

3. The method as recited in claim 1, wherein the lithium salt is lithium acetate dihydrate (CH₃CO₂Li.2H₂O), and the manganese salt and the nickel salt are manganese acetate tetrahydrate ((CH₃CO₂)₂Mn.4H₂O) and nickel(II) nitrate hexahydrate (Ni(NO₃)₂.6H₂O), respectively.

4. The method as recited in claim 1, wherein the gel is burnt at a temperature of 400˜500° C.

5. The method as recited in claim 1, wherein the first thermal treatment is performed at a temperature of 400˜500° C.

6. The method as recited in claim 1, wherein the second thermal treatment is performed at a temperature of 700˜1000° C.

7. A method for preparing a Li—Mn—Ni oxide for a lithium secondary battery having a composition of Li[NiₓLi_{(1/3-2x/3)}Mn_{(2/3-x/3)}O₂ (0.05<X<0.6), comprising the steps of:
a) preparing an aqueous solution by resolving lithium acetate dihydrate (CH₃CO₂Li.2H₂O), manganese acetate tetrahydrate ((CH₃CO₂)₂Mn.4H₂O) and nickel(II) nitrate hexahydrate (Ni(NO₃)₂.6H₂O) into distilled water;
b) forming gel by heating the aqueous solution at over 1000° C.;
c) preparing oxide powder by burning the gel;
d) performing a first thermal treatment on the oxide powder, and grinding the resultant; and
e) performing a second thermal treatment on the resultant powder at a temperature of 700˜1000° C., and grinding the resultant.

8. A Li—Mn—Ni oxide having a composition of Li[NiₓLi_{(1/3-2x/3)}Mn_{(2/3-x/3)}O₂ (0.05<X<0.6) prepared by using a method for preparing a Li—Mn—Ni oxide for a lithium secondary battery, the method comprising the steps of:
a) preparing an aqueous solution by resolving lithium salt, manganese salt and nickel salt into distilled water;
b) forming gel by heating the aqueous solution;
c) preparing oxide powder by burning the gel;
d) performing a first thermal treatment on the oxide powder, and grinding the resultant; and
e) performing a second thermal treatment on the resultant powder, and grinding the resultant.

9. A Li—Mn—Ni oxide having a composition of Li[NiₓLi_{(1/3-2x/3)}Mn_{(2/3-x/3)}O₂ (0.05<X<0.6) prepared by using a method for preparing a Li—Mn—Ni oxide for a lithium secondary battery, the method comprising the steps of:
a) preparing an aqueous solution by resolving lithium acetate dihydrate (CH₃CO₂Li.2H₂O), manganese acetate tetrahydrate ((CH₃CO₂)₂Mn.4H₂O) and nickel(II) nitrate hexahydrate (Ni(NO₃)₂.6H₂O) into distilled water;
b) forming gel by heating the aqueous solution at over 1000° C.;
c) preparing oxide powder by burning the gel;
d) performing a first thermal treatment on the oxide powder, and grinding the resultant; and
e) performing a second thermal treatment on the resultant powder at a temperature of 700˜1000° C., and grinding the resultant.

10. A lithium secondary battery including a Li—Mn—Ni oxide having a composition of Li[NiₓLi_{(1/3-2x/3)}Mn_{(2/3-x/3)}O₂ (0.05<X<0.6) which is prepared by using a method for preparing a Li—Mn—Ni oxide for a lithium secondary battery, the method comprising the steps of:
a) preparing an aqueous solution by resolving lithium salt, manganese salt and nickel salt into distilled water;
b) forming gel by heating the aqueous solution;
c) preparing oxide powder by burning the gel;
d) performing a first thermal treatment on the oxide powder, and grinding the resultant; and
e) performing a second thermal treatment on the resultant powder, and grinding the resultant.

11. A lithium secondary battery including a Li—Mn—Ni oxide having a composition of Li[NiₓLi_{(1/3-2x/3)}Mn_{(2/3-x/3)}O₂ (0.05<X<0.6) prepared by using a method for preparing a Li—Mn—Ni oxide for a lithium secondary battery, the method comprising the steps of:
a) preparing an aqueous solution by resolving lithium acetate dihydrate (CH₃CO₂Li.2H₂O), manganese acetate tetrahydrate ((CH₃CO₂)₂Mn.4H₂O) and nickel(II) nitrate hexahydrate (Ni(NO₃)₂.6H₂O) into distilled water;
b) forming gel by heating the aqueous solution at over 100° C.;
c) preparing oxide powder by burning the gel;
d) performing a first thermal treatment on the oxide powder, and grinding the resultant; and
e) performing a second thermal treatment on the resultant powder at a temperature of 700˜1000° C., and grinding the resultant.
